(19) United States
(12) Patent Application Publication
(10) Pub. No.: US 2010/0164680 A1
(43) Pub. Date: Jul. 1, 2010

(54) SYSTEM AND METHOD FOR IDENTIFYING PEOPLE

(75) Inventors: Jerry W. Yancey, Rockwall, TX (US); Valentin Francisco Gavito, JR., Heath, TX (US); Aya Nagao Bennett, Rockwall, TX (US); Deepak Prasanna, Rockwall, TX (US); Matthew P. DeLaquil, Rockwall, TX (US)

Correspondence Address: HOVEY WILLIAMS LLP, 10801 Mastin Blvd., Suite 1000, Overland Park, KS, 66210, US

(73) Assignee: L3 COMMUNICATIONS INTEGRATED SYSTEMS, L.P., Greenville, TX (US)

(21) Appl. No.: 12/347,180

(22) Filed: Dec. 31, 2008

(51) Int. Cl. G08B 23/00; G08B 29/00

(52) U.S. Cl. 340/5.32; 340/5.82; 340/5.83; 340/5.52

(57) ABSTRACT

A system for identifying a person includes at least one biometric sensor for sensing a biometric characteristic of the person; at least one signal sensor for sensing a signal emitted from a device carried by the person; and a computing device for comparing the sensed biometric characteristic and the sensed signal to known characteristics of the person in an attempt to identify the person.

### BACKGROUND

The present invention relates to identification systems and methods. More particularly, the invention relates to systems and methods for more quickly and accurately identifying people by sensing both biometric characteristics of people and signals from devices carried by the people.

Many types of security systems and methods are used to identify people and control access to secured areas and/or computer systems. For example, airports, governmental buildings, and other similar places often have security screening areas where guards check and verify tickets, badges, passports, driver's licenses, and other forms of identification. Similarly, many computer systems and buildings are secured by security systems with keypads that require the entry of passcodes or other security information or biometric security systems with fingerprint readers or retinal scanners.

Unfortunately, security systems that require guards to manually check identification and/or require persons to enter codes or submit to biometric scanning are labor-intensive, time-consuming and limit the number of people that can be identified in a given amount of time. Moreover, systems that require the entry, checking, or scanning of one or more forms of identification are relatively easy to circumvent by unauthorized persons who simply steal these forms of identification, especially when the unauthorized persons resemble the authorized persons. Security systems that rely on biometric scanning are generally harder to circumvent than other systems, but they are expensive to implement because they require costly equipment and access to known biometric data. Moreover, biometric systems are too slow for applications requiring identification of a large number of people in a short amount of time.

### SUMMARY

The present invention solves the above-described problems and provides a distinct advance in the art of identification systems and methods. More particularly, the present invention provides systems and methods for more quickly and accurately identifying people without many of the time-consuming and inefficient checking procedures of prior art systems.

One embodiment of the invention is an identification system comprising at least one biometric sensor for sensing a biometric characteristic of a person; at least one signal sensor for sensing a signal emitted from a device carried by the person; and a computing device for comparing the sensed biometric characteristic and the sensed signal to known characteristics of the person in an attempt to identify the person.

The biometric sensor may be a fingerprint reader, retinal scanner, facial recognition scanner, weight sensor, height sensor, body temperature sensor, gait sensor, heartbeat sensor, or any other sensor or device capable of sensing biometric characteristics of persons to be identified. The signal sensor may be a sensor or combination of sensors that sense signals from wireless telephones, portable computers, navigation devices, garage door openers, keyless entry transmitters, electronic tags, or any other devices carried by persons to be identified. Both the biometric sensor and signal sensor may be positioned in or near a doorway, aisle, security gate, or other choke point to sense biometric characteristics and signals as persons pass through the choke point.

The computing device may include any number of processors, controllers, or other logic devices and is configured for comparing the sensed biometric characteristics and signals to known characteristics of a person in an attempt to identify that person. For example, if the biometric sensor senses that the person is approximately 190 pounds and the signal sensor senses that the person is carrying a mobile phone with a particular serial number of other identification, the computing device compares this sensed information to the person's known weight and mobile phone type to see if it matches.

The known characteristics for any number of people may be collected and stored in a database accessible by the computer device. In one embodiment, the known characteristics are gathered passively over time as a person repeatedly passes through the sensed choke point or other similar sensed areas. For example, each time the person passes through the choke point, the system senses the person's biometric characteristics and signal sources and builds a profile for the person. For example, over time, the sensors may sense that the person is between 190-200 pounds, approximately 6′ tall, has a 2′ gait, always carries a particular mobile phone, and frequently carries a particular WiFi-enabled laptop computer. In another embodiment, the known characteristics may be actively entered by the persons to be identified or another person at a sensing and data entry station. For example, a person may first swipe a driver's license or other form of identification and then enter information about his or her biometric characteristics, telephone, and other sources of signals.

The system may also include an input device, such as a ticket reader, a credit card reader, an identification reader, or a keypad to obtain preliminary identification information for a person so that the computing device may retrieve the known characteristics of that person. For example, before or after a person passes through the choke point and is sensed as described above, the person may be prompted to insert his or her airline ticket, driver's license, or other form of identification into the input device.

The computing device uses the identification information to retrieve the known characteristics of the person for comparison with the sensed information. For privacy reasons, the identification information does not have to include the person's name or other personal information.

The system may further include a notification device, such as a display, an audible alarm, a visual alarm, or an indicator, for notifying others when the sensed biometric characteristics or the sensed signals do not match the known characteristics of a person. The system may also include an access control device such as a gate, locked door, etc. for preventing the person from accessing an area until the control device determines that the sensed biometric characteristics and the sensed signals match the known characteristics.

These and other important aspects of the present invention are described more fully in the detailed description below.

### BRIEF DESCRIPTION OF THE DRAWING FIGURES

Embodiments of the present invention are described in detail below with reference to the attached drawing figures, wherein:

FIG. 1 is a block diagram depicting components of an identification system constructed in accordance with an embodiment of the invention.

FIG. 2 is a block diagram depicting components of an exemplary input device that may be a part of the identification system of FIG. 1.

FIG. 3 is a schematic diagram of a choke point at which sensors of the identification system may be mounted.

FIG. 4 is a perspective view of the input device of FIG. 2.

FIG. 5 is a flow chart depicting exemplary steps in a method of using the identification system.

The drawing figures do not limit the present invention to the specific embodiments disclosed and described herein. The drawings are not necessarily to scale, emphasis instead being placed upon clearly illustrating the principles of the invention.

### DETAILED DESCRIPTION

The following detailed description of the invention references the accompanying drawings that illustrate specific embodiments in which the invention can be practiced.

The embodiments are intended to describe aspects of the invention in sufficient detail to enable those skilled in the art to practice the invention. Other embodiments can be utilized and changes can be made without departing from the scope of the present invention. T he following detailed description is, therefore, not to be taken in a limiting sense. The scope of the present invention is defined only by the appended claims, along with the full scope of equivalents to which such claims are entitled.

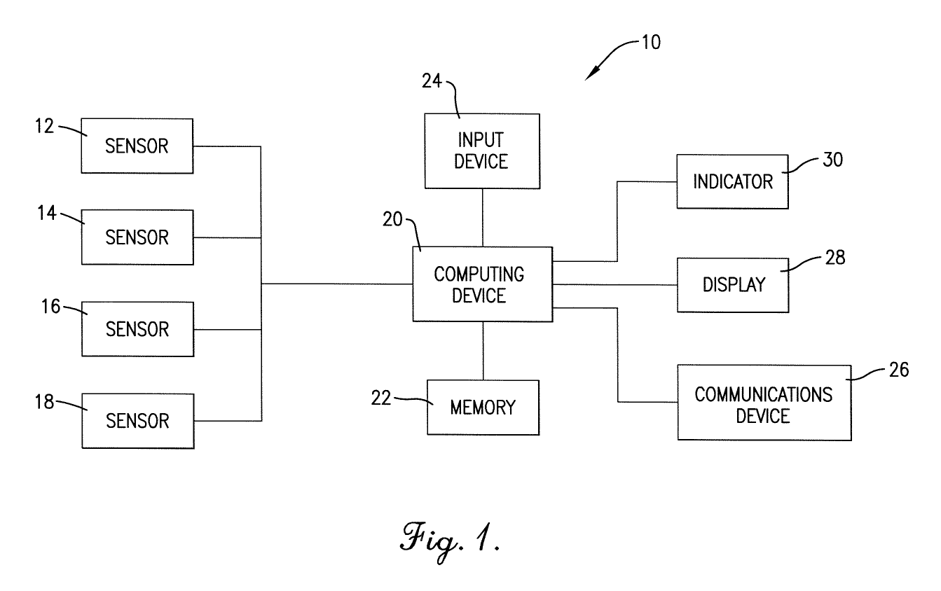

Turning now to the drawing figures, and particularly FIG. 1, components of an identification system 10 constructed in accordance with an embodiment of the invention are illustrated. The illustrated identification system 10 comprises at least one biometric sensor 12, 14 (two being shown as an example); at least one signal sensor 16, 18 (again, two being shown as an example); a computing device 20; memory 22; an input device 24; a communications device 26; a display 28; and an indicator 30. The identification system 10 may be used to secure or control access to any secured area or device such as an airport boarding area, building, stadium, computer system, security system, locked door, or any other system or device.

In more detail, the biometric sensors 12, 14 may include a fingerprint reader, retinal scanner, facial recognition scanner, weight sensor, height sensor, body temperature sensor, gait sensor, heartbeat sensor, or any other sensor or device capable of sensing a biometric characteristic of a person. Although the system 10 may include a single biometric sensor, it preferably includes several, and as many as ten or more, to gather as many biometric characteristics as possible.

The signal sensors 16, 18 may include a receiver or combination of receivers for sensing signals from devices carried by a person to be identified. For example, the signal sensors may sense signals transmitted from a wireless telephone, a portable computer, a navigation device, a garage door opener, a keyless entry transmitter, an electronic tag, or any other device that can be carried by a person to be identified. To sense information from passive devices that do not regularly transmit signals, the signal sensors may include an interrogation transmitter and circuit much like those used in RFID systems.

The biometric sensors 12, 14 and signal sensors 16, 18 are preferably positioned in or near a doorway, aisle, chute, security gate, or other choke point to sense biometric characteristics and signals as persons pass through the choke point. For example, as shown in FIG. 3, two of the sensors 12, 14 may be positioned along one side of a choke point 32 and two of the sensors 16, 18 may be positioned along the other side of the choke point to sense biometric characteristics and signals as persons pass therethrough in the direction of the arrow. At least some of the sensors are preferably spaced along the length of the choke point 32 to sense a person's walking gait and/or other characteristics requiring spaced sensors. The sensors may also be oriented in different directions to account for persons who may be facing or otherwise oriented closer to some of the sensors than others. The particular number and positioning of the sensors shown in FIG. 3 can be altered without departing from the scope of the invention.

The computing device 20 is configured for comparing the sensed information described above to known characteristics of a person in an attempt to identify the person. The computing device 20 may include any number of processors, controllers, integrated circuits, programmable logic devices, or other computing devices and resident or external memory for storing data and other information accessed and/or generated by the system. The computing device 20 may be coupled with the sensors 12-18 and other components of the system 10 through wired or wireless connections to enable information to be exchanged between the various components.

The computing device 20 may implement a computer program and/or code segments to perform some the functions described herein. The computer program may comprise an ordered listing of executable instructions for implementing logical functions in the computing device. The computer program can be embodied in any computer-readable medium for use by or in connection with an instruction execution system, apparatus, or device, and execute the instructions. In the context of this application, a “computer-readable medium” can be any means that can contain, store, communicate, propagate or transport the program for use by or in connection with the instruction execution system, apparatus, or device. The computer-readable medium can be, for example, but not limited to, an electronic, magnetic, optical, electro-magnetic, infrared, or semi-conductor system, apparatus, device, or propagation medium. More specific, although not inclusive, examples of the computer-readable medium would include the following: an electrical connection having one or more wires, a random access memory (RAM), a read-only memory (ROM), an erasable, programmable, read-only memory (EPROM or Flash memory), a portable computer diskette, and a portable compact disk read-only memory (CDROM). The memory may be integral with the computing device, stand-alone memory, or a combination of both. The memory may include, for example, removable and non-removable memory elements such as RAM, ROM, Flash, magnetic, optical, USB memory devices, and/or other conventional memory elements.

The memory 22 may store the known characteristics of any number of people and various other data associated with operation of the system 10, such as the computer program and code segments mentioned above, or other data for instructing the computing device 20 and other device elements to perform the steps described herein. The various data stored within the memory 22 may be associated within one or more databases to facilitate retrieval of the information. The memory 24 may be integrated into the computing device 20, may be stand-alone memory positioned in the same enclosure as the computing device 20, or may be external memory accessible by the computing device.

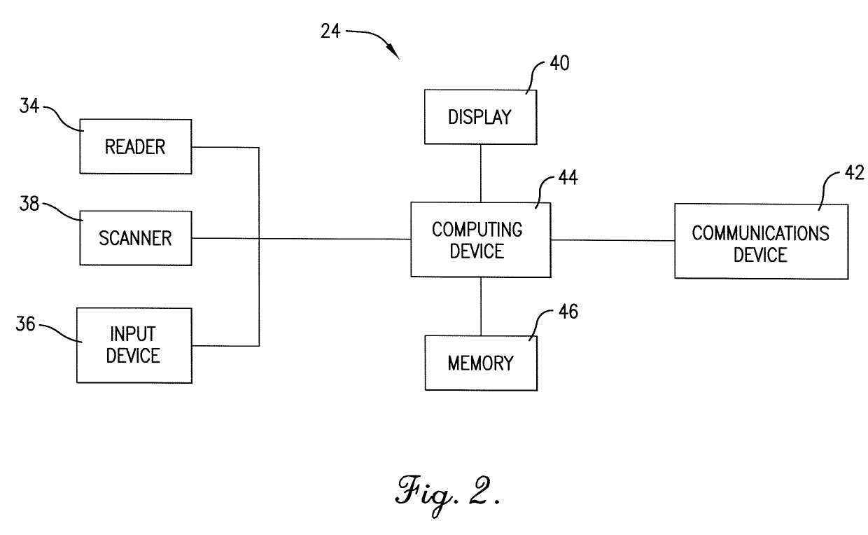

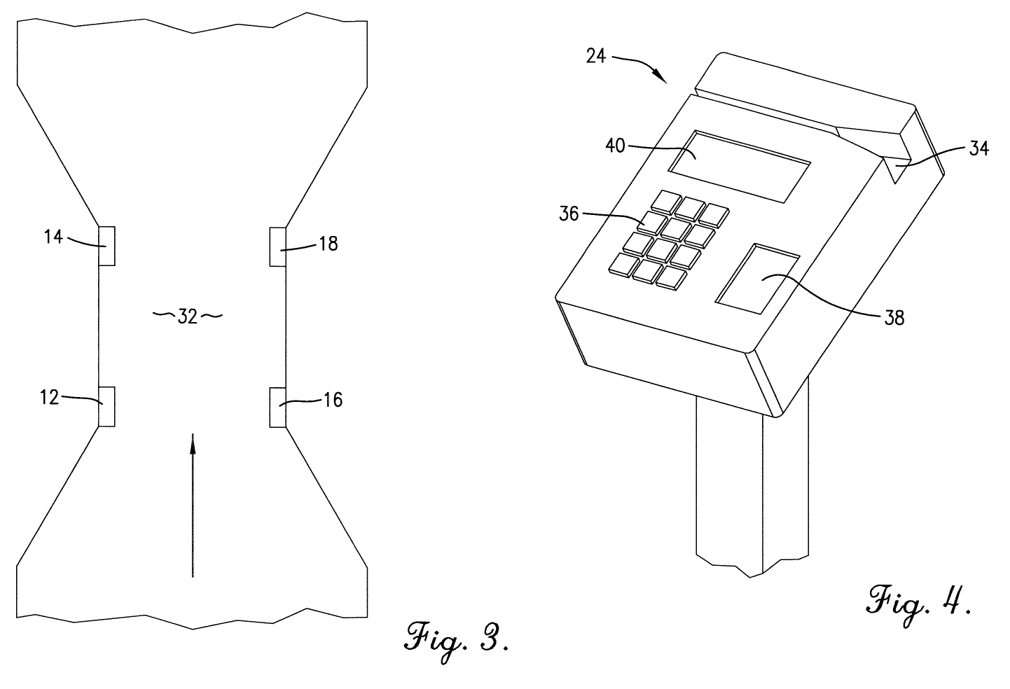

The input device 24 is used to preliminarily identify a person before or after he or she passes through the choke point 32 described above. The input device may include a ticket reader, a credit card reader, an identification reader, a keypad, or any other device for receiving identification information about a person. An exemplary embodiment of the input device 24 is shown in FIGS. 2 and 4 and includes a card or ticket reader 34, a keypad or other input device 36, a thumb-print or retinal scanner 38, a touch-screen display 40, a communications device 42, a computing device, 44, and memory 46. A guard, person to be identified, or other person may use the input device 24 to scan a ticket, license, badge, or other form of identification, enter a passcode, or scan or read a thumb-print or other biometric characteristic of a person to be identified to obtain preliminary identification information for that person. The computing device uses the identification information read or otherwise obtained by the input device 24 to retrieve the known characteristics for the person from memory. For example, after a person to be identified passes through the choke point 32 and is sensed as described above, the person may be prompted to scan his or her airline ticket, driver's license, or other form of identification into the reader 34. The input device then obtains preliminary identification information from the ticket or other form of identification and passes it to the computing device 20 of the identification system 10. The computing device 20 then uses the identification information to retrieve the known characteristics of the person for comparison with the sensed information. For privacy reasons, the identification information does not have to include the person's name or other personal information.

The communications device 26 enables the system 10 to communicate with other electronic devices through a communication network, such as the Internet, a local area network, a wide area network, an ad hoc or peer to peer network, or a direct connection such as a USB, Firewire, or Bluetooth™ connection, etc. For example, the system 10 may obtain known characteristics about persons stored in remote memory via the communications device 26. The communications device may communicate utilizing wired data transfer methods or wireless data transfer methods such as WiFi (802.11), Wi-Max, Bluetooth™, ANT®, ultra-wideband, infrared, cellular telephony, radio frequency, etc.

In one embodiment, the communications device is a cellular transceiver for transmitting and receiving communications over a cellular phone network such as those operated by Sprint, AT&T®, Verizon®, and other companies. The cellular phone network may operate with GSM (Global System for Mobile communications), CDMA (Code Division Multiple Access), or any other known standards.

The display 28 is operable to display various information relating to the identification system 10 and its operation. The indicator 30 is a notification device for notifying others when the sensed biometric characteristic or the sensed signal do not match the known characteristics of the person and may include an audible alarm, a visual alarm, and/or any other notification device.

The system 10 may also include an access control device (not shown) such as a gate, locked door, etc. for preventing persons from accessing certain areas until the control device determines that the sensed biometric characteristic and the sensed signal match the known characteristics.

The system 10 may also include a power source (not shown) for providing electrical power to the other components of the system. The power source may comprise conventional power supply elements, such as batteries, battery packs, power conduits, connectors, and receptacles operable to receive batteries, battery connectors, or power cables.

The system 10 may also include I/O ports that permit data and other information to be transferred to and from the computing device 20 or its memory 22. The I/O ports may include a Secure Disk Digital (SD) card slot, Mini SD Card slot, Micro SD Card slot or the like for receiving removable SD cards, Mini SD Cards, Micro SD Cards, or the like, and a USB port for coupling with a USB cable connected to another computing device such as a personal computer.

The components shown in FIGS. 1-4 and described herein need not be physically connected to one another since wireless communication among the various depicted components is permissible and intended to fall within the scope of the present invention.

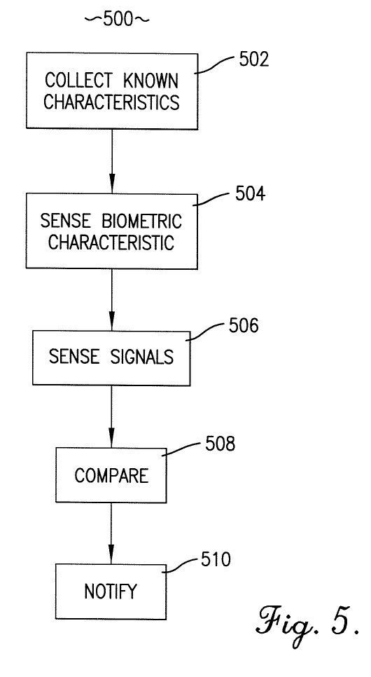

The flow chart of FIG. 5 shows the functionality and operation of a preferred implementation or method 500 of using the identification system 10. In this regard, some of the blocks of the flow chart may represent a module segment or portion of code of the computer programs of the present invention which comprise one or more executable instructions for implementing the specified logical function or functions. In some alternative implementations, the functions noted in the various blocks may occur out of the order depicted in FIG. 5. For example, two blocks shown in succession in FIG. 5 may in fact be executed substantially concurrently, or the blocks may sometimes be executed in the reverse order depending upon the functionality involved.

In step 502, known characteristics for at least one person are collected and stored in memory accessible by the computing device 20. In one embodiment, the known characteristics are gathered passively over time as a person repeatedly passes through the sensed choke point 32 or other similar sensed areas. Each time the person passes through the choke point, the system senses the person's biometric characteristics and signal sources and builds a profile for the person. For example, the sensors may sense that the person is between 190-200 pounds, approximately 6′ tall, has a 2′ gait, always carries a particular mobile phone, and frequently carries a particular WiFi-enabled laptop computer. The system uses these sensed characteristics to build a profile of known characteristics for the person. In another embodiment, the known characteristics may be actively collected by the person or another person and entered into the input device 24 or a similar data entry station. Once known characteristics are gathered for a person, the system may use them to identify the person.

In step 504, at least one biometric characteristic is sensed for a person passing through the choke point 32. Likewise, in step 506, at least one signal is sensed from an electronic device carried by the person.

Once the biometric characteristics and signals are sensed, they are compared to known characteristics of the person in step 508. For example, if one or more of the biometric sensors 12, 14 sense that the person is approximately 190 pounds and one of the signal sensors 16, 18 senses that the person is carrying a mobile phone with a particular serial number of other identification, this sensed information is compared to known information for the person to see if it matches.

Step 510 then notifies the person being identified, a guard, and/or another person if the sensed information matched the known information. For example, if the information matches, the person being identified may be prompted (by a green light, recorded voice, etc.) to proceed to a restricted area. Conversely, if the information does not match, the person may be told to stop and/or proceeded to another security area for further security screening.

In some embodiments, a person may be successfully “identified” even if some of the sensed information does not match the known information. For example, if a person's known profile shows that the person is 5′10″ tall, approximately 175 lbs., carries a particular telephone, and frequently carries a particular computer, that person may be allowed to enter a secured area if the sensors 12-18 sense that the person is approximately 5′10″ tall, 175 lbs., is carrying the known telephone, but is carrying a different computer. This allows the system 10 to account for occasional variances such as when a person obtains a new phone or computer.

Likewise, the sensitivity of the system 10 may be calibrated based on the security level of the area being accessed. For example, when controlling access to a highly secured area such as a top-secret building, the system 10 may only allow a person to pass if all of the sensed information matches the known information. Conversely, when controlling access to a low-security area such as a sports stadium, the system may allow a person to pass if some percentage (e.g. 80% or 90%) of the sensed information matches the known information.

The system may also be programmed to give more weight to certain sensed information. For example, the system may require a nearly perfect match of certain biometric data such as a person's height and weight but may allow more discrepancies in a person's gait, heart rate, telephone identification, and other types of information that are more variable and/or subject to change.

Although the invention has been described with reference to the preferred embodiment illustrated in the attached drawing figures, it is noted that equivalents may be employed and substitutions made herein without departing from the scope of the invention as recited in the claims. For example, the particular equipment illustrated and described herein are merely examples of equipment that may be used to implement the present invention and may be replaced with other equipment without departing from the scope of the present invention.

Having thus described the preferred embodiment of the invention, what is claimed as new and desired to be protected by Letters Patent includes the following:

1. An identification system comprising:
at least one biometric sensor for sensing a biometric characteristic of a person;
at least one signal sensor for sensing a signal emitted from a device carried by the person; and
a computing device for comparing the sensed biometric characteristic and the sensed signal to known characteristics of the person in an attempt to identify the person.

2. The system as set forth in claim 1, wherein the biometric sensor is a fingerprint reader, retinal scanner, facial recognition scanner, weight sensor, height sensor, body temperature sensor, gait sensor, or heartbeat sensor.

3. The system as set forth in claim 1, wherein the signal sensor senses signals from a wireless telephone, a portable computer, a navigation device, a garage door opener, a keyless entry transmitter, or an electronic tag.

4. The system as set forth in claim 1, wherein the known characteristics of the person are collected and stored in memory accessible by the computing device.

5. The system as set forth in claim 1, further including an input device coupled with the computing device for receiving identification information for the person.

6. The system as set forth in claim 1, wherein the input device includes a ticket reader, a credit card reader, an identification reader, or a keypad.

7. The system as set forth in claim 5, wherein the computing device uses the identification information for the person to retrieve the known characteristics of the person.

8. The system as set forth in claim 1, further including a notification device for notifying others when the sensed biometric characteristic or the sensed signal do not match the known characteristics of the person.

9. The system as set forth in claim 8, wherein the notification device is a display, an audible alarm, a visual alarm, or an indicator.

10. The system as set forth in claim 1, further including an access control device controlled by the computing device for providing the person access to a secured area when the control device determines that the sensed biometric characteristic and the sensed signal match the known characteristics.

11. A system for identifying a person, the system comprising:
a plurality of biometric sensors for sensing biometric characteristics of the person;
at least one signal sensor for sensing signals emitted from devices carried by the person;
an input device for receiving identification information for the person;
a computing device operable to retrieve known characteristics for the person based on the identification information, compare the sensed biometric characteristics and the sensed signals to the known characteristics, and provide an indication of whether the sensed biometric characteristics and the sensed signals match the known characteristics.

12. The system as set forth in claim 11, wherein the biometric sensors include a fingerprint reader, retinal scanner, facial recognition scanner, weight sensor, height sensor, body temperature sensor, gait sensor, or heartbeat sensor.

13. The system as set forth in claim 11, wherein the signal sensor senses signals from a wireless telephone, a portable computer, a navigation device, a garage door opener, a keyless entry transmitter, or an electronic tag.

14. The system as set forth in claim 11, wherein the known characteristics of the person are collected and stored in a database accessible by the computing device.

15. The system as set forth in claim 11, wherein the input device is a ticket reader, a credit card reader, an identification reader, or a keypad.

16. The system as set forth in claim 11, further including a notification device for notifying others when the sensed biometric characteristic or the sensed signal do not match the known characteristics of the person.

17. The system as set forth in claim 16, wherein the notification device is a display, an audible alarm, a visual alarm, or an indicator.

18. The system as set forth in claim 11, further including an access control device controlled by the computing device for providing the person access to a secured area when the control device determines that the sensed biometric characteristic and the sensed signal match the known characteristics.

19. A method for identifying a person, the method comprising:
sensing a biometric characteristic of the person with a biometric sensor;
sensing a signal emitted from a device carried by the person with a signal sensor; and
comparing in a computing device the sensed biometric characteristic and the sensed signal to known characteristics of the person in an attempt to identify the person.

20. The method as set forth in claim 19, wherein the biometric sensor is a fingerprint reader, retinal scanner, facial recognition scanner, weight sensor, height sensor, body temperature sensor, gait sensor, or heartbeat sensor.

21. The method as set forth in claim 19, wherein the signal sensor senses signals from a wireless telephone, a portable computer, a navigation device, a garage door opener, a keyless entry transmitter, or an electronic tag.

22. The method as set forth in claim 19, wherein the known characteristics of the person are collected and stored in a database accessible by the computer device.

23. The method as set forth in claim 19, further including the step of receiving identification information for the person with an input device coupled with the computing device.

24. The method as set forth in claim 23, wherein the input device is a ticket reader, a credit card reader, an identification reader, or a keypad.

25. The method as set forth in claim 23, wherein the computing device uses the identification information for the person to retrieve the known characteristics of the person.

26. The method as set forth in claim 19, further including the step of notifying others when the sensed biometric characteristic or the sensed signal do not match the known characteristics of the person.

27. The method as set forth in claim 26, wherein the notification device is a display, an audible alarm, a visual alarm, or an indicator.

28. The method as set forth in claim 19, further the step of providing the person access to a secured area when the control device determines that the sensed biometric characteristic and the sensed signal match the known characteristics.
